(19) United States
(12) Patent Application Publication
(10) Pub. No.: US 2019/0111807 A1
(43) Pub. Date: Apr. 18, 2019

(54) METHOD FOR CONTROLLING A VEHICLE SEAT

(71) Applicant: Conti Temic microelectronic GmbH, Nurernberg (DE)

(72) Inventor: Christoph Hassenpflug, Hildesheim (DE)

(21) Appl. No.: 16/158,819

(22) Filed: Oct. 12, 2018

(30) Foreign Application Priority Data
Oct. 13, 2017 (DE) 102017218396.9

(51) Int. Cl. B60N 2/02; B60R 21/0134

(52) U.S. Cl. CPC B60N 2/0276; B60R 21/01554; B60R 21/0134

(57) ABSTRACT

The disclosure relates to a method for controlling a vehicle seat of a vehicle, wherein a position of the vehicle seat or a part of it can be adjusted within an adjustment range, the size of which can be determined, and wherein the method has the steps of determining a measure of danger, which indicates a degree of danger for a vehicle seat occupant as a result of an accident, on the basis of environmental data relating to the vehicle; and determining the size of the adjustment range on the basis of the determined measure of danger.

### BRIEF DESCRIPTION OF THE DRAWINGS

An exemplary embodiment of the subject matter of the disclosure will be described in detail below with reference to the appended figures.

In the drawings:

FIG. 1 shows a schematic plan view of a vehicle having vehicle seat occupant protection based on one embodiment of the subject matter of the disclosure;

FIG. 2 shows a schematic side view of the driver's seat in the vehicle from FIG. 1; and

FIG. 3 shows a flowchart which illustrates the performance of one embodiment of the method according to the disclosure for controlling a vehicle seat on the basis of the driver's seat from FIG. 2.

### DETAILED DESCRIPTION

The disclosure relates to a method for controlling a vehicle seat, in particular a motor vehicle seat, and to an arrangement for controlling a vehicle seat and to a vehicle, in particular a motor vehicle, having a corresponding arrangement.

The prior art discloses various methods for making it possible to protect a vehicle seat occupant in the event of imminent danger by automatically actuating an actuator system.

The publication DE 10 2011 084 204 A1 discloses a method for controlling a safety actuator system of a motor vehicle, in which a danger model of the motor vehicle and an ability to control the motor vehicle by its driver are determined and the safety actuator system is controlled on the basis of these values. When controlling the safety actuator system, it is possible to adjust a restraint means based on a vehicle seat device, wherein this restraint means can comprise an adjustment of positions of the vehicle seat.

The document WO 2004/103779 A1 discloses an occupant protection system for vehicles, with which a dangerous situation is detected using an environmental sensor system, and a vehicle seat can be adjusted at a higher speed if the dangerous situation is detected.

The document DE 10 2013 220 551 A1 describes a method for adapting the body support of a person sitting on a vehicle seat, in which an adaptation event requiring adaptation of the body support is predicted and the body support is started before the adaptation event occurs.

The known methods which change the position of a vehicle seat by means of an actuator system automatically act on the seat adjustment and are therefore effective only in acute dangerous situations.

The object of the disclosure is to provide a method for controlling a vehicle seat which enables improved vehicle seat occupant protection.

This object is achieved by the subject matter of the independent claims. Refinements of the subject matter of the disclosure are defined in the dependent claims.

A first aspect provides a method for controlling a vehicle seat of a vehicle, wherein a position of the vehicle seat or a part of it can be adjusted within an adjustment range, the size of which can be determined. The method according to the disclosure determines a measure of danger, which indicates a degree of danger for a vehicle seat occupant as a result of an accident, wherein the measure of danger is determined on the basis of environmental data relating to the vehicle. The environmental data contain, for example, information relating to the environment of the vehicle (e.g. a predetermined area surrounding the vehicle). The method according to the disclosure also determines the size of the adjustment range of the vehicle seat on the basis of the determined measure of danger.

The method according to the disclosure has the advantage that the adjustment possibilities (or the adjustment range) of a vehicle seat can be restricted in the event of an increased degree of danger. This makes it possible to counteract a situation in which, for example, the seat position is adjusted in such a manner that the vehicle seat occupant can direct his attention to the area surrounding the vehicle only to a limited extent or can control the vehicle only to a limited extent.

A low degree of danger for the vehicle seat occupants is present, for example, when there is the threat of a collision with a small animal, for example a hedgehog or a cat. The degree of danger increases if, for example, there is the threat of a collision with a large animal such as a deer or a stag. A high degree of danger exists, for example, if there is the threat of a collision with an automobile. It is clear from these examples that a higher degree of danger corresponds to a higher risk of an accident for the vehicle seat occupant.

The method according to the disclosure is therefore used, in particular, to protect a vehicle seat occupant in a vehicle, wherein the size of the adjustment range of the vehicle seat is determined on the basis of the determined measure of danger. For example, an adjustment possibility for the vehicle seat is determined in the form of an angular range and/or a displacement range.

In this case, the vehicle seat can be adjusted in a predefined adjustment range, for example using a seat adjustment device, as a result of operation by the vehicle seat occupant (occupant for short) sitting on the respective vehicle seat. The adjustment can be carried out manually. However, the adjustment can also be carried out using an actuator system. The actuator system may be an electrical, hydraulic or other suitable actuator system. In one preferred embodiment, the actuator system is an electromechanical actuator system comprising one or more servomotors or electric motors, for example. The actuator system can also be or comprise a mechanical actuator system in which at least some of the adjustments of the vehicle seat are effected by the operator exerting force.

The vehicle can also have a control device which determines the measure of danger on the basis of environmental data. The control device can be implemented by means of a single controller in the vehicle, but may also possibly be distributed among a plurality of control units in the vehicle.

In one preferred embodiment of the method, the size of the adjustment range is restricted all the more, the greater the determined measure of danger. The restriction or reduction in the adjustment range of the vehicle seat is selected, in particular, in such a manner that the permitted deviation from an upright position of the vehicle seat with a viewing direction in the direction of travel is reduced. This upright position is defined in such a manner that the backrest of the vehicle seat runs perpendicular to the longitudinal direction of the motor vehicle and the back contact area of the backrest faces forward in the direction of travel and the seating surface of the vehicle seat runs perpendicular to the vertical direction of the motor vehicle.

In the case of an electromechanical actuator system, the adjustment range can be reduced by virtue of the control device allowing only adjustment commands within the reduced adjustment range. In the case of a mechanical actuator system, the control device can actuate a blocking element, for example, which restricts the movement of the vehicle seat.

In one preferred embodiment, if the position of the vehicle seat or the part of it is outside the determined adjustment range, the vehicle seat or the part of it is brought into the determined adjustment range by means of the actuator system.

In another embodiment of the method according to the disclosure, the predefined adjustment range comprises one or more of the following spatial ranges:
a first angular range which stipulates a permissible rotation of the vehicle seat about an axis which runs in the vertical direction of the vehicle;
a second angular range which stipulates a permissible rotation of the vehicle seat about an axis which runs in the transverse direction of the vehicle;
a displacement range which stipulates a permissible displacement of the vehicle seat in the longitudinal and/or vertical direction of the vehicle;
an inclination range which stipulates a permissible inclination of the seating surface and/or of the backrest of the vehicle seat about an axis in the transverse direction of the vehicle.

The first angular range defined above is relevant, in particular, when the vehicle can be operated in an autonomous operating mode without user intervention. In this case, the vehicle seat can possibly be pivoted away from an orientation in the longitudinal direction of the vehicle.

In one preferred embodiment, the size of the adjustment range is not restricted as long as the determined measure of danger does not exceed a first threshold. A “tolerance threshold” is therefore provided for the measure of danger, below which threshold the adjustment range is not changed.

In one preferred embodiment, a second threshold which represents a measure of danger having a higher degree of danger than the first threshold is defined in addition to the first threshold, and the size of the adjustment range is restricted only when the determined measure of danger is between the first threshold and the second threshold. This provides a measure of danger range (between the first and second thresholds) in which the adjustment range of the vehicle seat is restricted.

In another embodiment, if the determined measure of danger exceeds the second threshold, the vehicle seat or the part of it is automatically moved into a position which constitutes little harm to the vehicle seat occupant in the event of an accident. This ensures that the vehicle seat occupant is quickly and automatically (e.g. without the assistance of the vehicle seat occupant) moved into a safe position in the event of a particularly high measure of danger. In other words, the safety of the vehicle occupants is therefore increased in the case of an acute risk of an accident.

In another configuration of the method according to the disclosure, a message is output to the vehicle seat occupant if there is an increased measure of danger. This makes the vehicle seat occupant aware of the fact that there is an increased measure of danger.

In another configuration, if the vehicle seat or the part of it is in a position outside the determined adjustment range, the vehicle seat occupant is made aware of this situation with a message. If, for example, the vehicle seat is outside the reduced adjustment range after the determined adjustment range has been reduced by the control device, the vehicle seat occupant is made aware of the fact that the position of the vehicle seat is outside the reduced adjustment range using a message. This makes it possible for the vehicle seat occupant to correct his position or to move the vehicle seat into a position inside the determined adjustment range. In one preferred embodiment, the message is in the form of a request which indicates to the vehicle seat occupant how he should move his vehicle seat in order to reach the reduced adjustment range.

In another configuration of the method according to the disclosure, the vehicle seat or the part of it is automatically adjusted into a position inside the determined adjustment range when the vehicle seat occupant does not react or does not accordingly react (e.g. the vehicle seat is not adjusted by the vehicle seat occupant in such a manner that it is within the determined adjustment range) to the message indicating that the vehicle seat or the part of it is in a position outside the determined adjustment range. This ensures, without user intervention, that the vehicle seat occupies a position in the determined adjustment range if the adjustment range is reduced.

In another configuration of the method according to the disclosure, if the determined measure of danger results in a reduction or restriction in the size of the adjustment range and if one or more operating elements are not in an operating position, the operating element(s) is/are automatically moved into an operating position in which it/they can be operated by the vehicle seat occupant sitting on the respective vehicle seat. In this case, the vehicle seat is preferably a driver's seat and the operating element(s) comprise(s) a steering wheel and/or one or more driving pedals of the vehicle. This embodiment of the subject matter of the disclosure is preferably used in a vehicle which can be operated in an autonomous operating mode in which the operating elements are arranged in a retracted position in order to enlarge the passenger compartment.

In another embodiment of the method according to the disclosure, the environmental data contain information relating to one or more road users and/or objects in the environment of the vehicle, in particular information relating to the relative movement of the road user(s) and/or objects with respect to the motor vehicle, and/or information relating to the road type currently being driven along by the motor vehicle and/or relating to the current traffic density and/or relating to current weather conditions and/or relating to current visibility conditions. The degree of danger or the corresponding measure of danger is then suitably determined on the basis of these variables. In particular, the degree of danger is all the greater, the higher the relative speed between the motor vehicle and other road users or objects and the shorter the distance between the motor vehicle and the road users or objects on the basis of the relative movement. In addition, the degree of danger is preferably greater in the case of a road type with oncoming traffic than in the case of a road type without oncoming traffic. The degree of danger also preferably increases in the case of a higher traffic density and in the case of poor weather conditions and poor visibility conditions.

Depending on the configuration of the method according to the disclosure, the environmental data may come from different sources. In one preferred variant, the environmental data are sensor data from an environmental sensor system installed in the vehicle, wherein the environmental sensor system preferably comprises one or more cameras and/or one or more radar sensors and/or one or more lidar sensors and/or one or more ultrasonic sensors and/or one or more rain sensors. In one preferred variant of this embodiment, the degree of danger increases with decreasing detection range of the environmental sensor system. When using one or more rain sensors, the degree of danger may also increase when the strength of the rain increases on the basis of the data from the rain sensor.

In another configuration of the method according to the disclosure, the environmental data are at least partially received via vehicle-to-vehicle communication (Car2Car) and/or Vehicle-to-infrastructure communication (Car2X) and/or the environmental data are at least partially determined by a navigation system in the vehicle. For example, the navigation system of the vehicle may determine the current position of the vehicle using satellite-based positioning and can compare this position with a position in a digital map containing information relating to this position, for example relating to the road type being traveled along.

Another aspect of the subject matter of the disclosure provides an arrangement for controlling a vehicle seat. The arrangement comprises a seat adjustment device for adjusting a position of the vehicle seat or a part of it within an adjustment range, the size of which can be determined, and a control device. The control device is also set up to determine a measure of danger, which indicates a degree of danger for a vehicle seat occupant as a result of an accident, on the basis of environmental data relating to the vehicle, and to determine the size of the adjustment range on the basis of the determined measure of danger.

In one preferred embodiment of the arrangement, the arrangement also comprises an environmental sensor system for providing the environmental data.

In another embodiment of the arrangement, the control device is also set up to carry out the method according to the first aspect or embodiments thereof.

A third aspect of the subject matter of the disclosure provides a vehicle, in particular a motor vehicle, having the arrangement according to the second aspect or embodiments thereof.

In one preferred embodiment of the vehicle, the vehicle comprises a vehicle seat which can be controlled by the arrangement. The vehicle seat may be, in particular, an adult seat, preferably a driver's seat and/or a passenger seat, and/or may have one or more child seats, wherein at least one child seat is preferably a child seat which is extraneous to the vehicle, is installed in the vehicle by a user and is connected to the control device via a communication interface.

Advantageous configurations of the method are advantageous configurations of the arrangement and vice versa, provided that they can be used.

The vehicle 1 (also referred to as a motor vehicle 1 below) shown in plan view in FIG. 1 is an automobile having a plurality of occupant seats, wherein only the driver's seat 4 is illustrated for reasons of clarity. The motor vehicle 1 has an arrangement for controlling the driver's seat 4. This arrangement includes a seat adjustment device 5, which is designed to adjust the driver's seat 4, and a control device 3 which is connected to the seat adjustment device 5 and is described in more detail further below.

One embodiment of the method according to the disclosure is explained below on the basis of this driver's seat 4, wherein the method can generally also be carried out for further seats in the motor vehicle and, in particular, for the passenger seat.

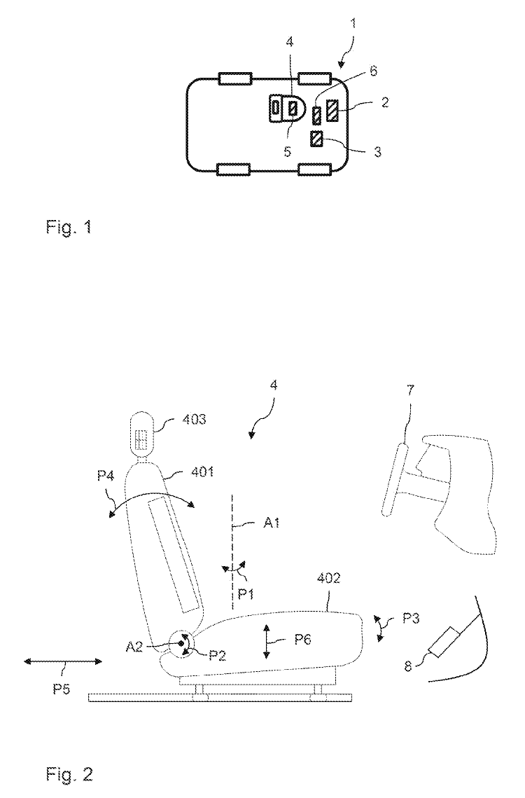

The driver's seat 4 can be adjusted into different positions by means of an electromechanical actuator system 5, wherein the actuator system is only schematically indicated in FIG. 1. The actuator system 5 may also be another suitable actuator system, for example a mechanical or hydraulic actuator system. The exact adjustment possibilities on the basis of this actuator system are explained further below on the basis of FIG. 2.

The actuator system 5 is an example of the seat adjustment device. The actuator system 5 contains a multiplicity of servomotors in order to adjust the seat. In addition to servomotors, the actuator system may possibly also comprise further types of actuators, for example also pneumatic actuators for filling air bubbles in the seat.

The motor vehicle 1 also contains an environmental sensor system 2 in order to capture the environment of the motor vehicle, in particular the front area in front of the motor vehicle. The environmental sensor system 2 may have a different configuration. In particular, the environmental sensor system 2 may contain one or more cameras or one or more radar sensors or one or more lidar sensors and possibly also other types of sensors which can be used to capture the area surrounding the motor vehicle. The motor vehicle 1 also contains a control device 3 which evaluates, in particular continuously evaluates, the data captured using the environmental sensor system 2 and, on the basis thereof, determines a measure of danger, which represents a degree of danger for the occupant (also called vehicle seat occupant) sitting on the driver's seat as a result of an accident, on the basis of the data from the environmental sensor system 2. Methods for determining such a measure of danger are known from the prior art. A known method for determining such a measure of danger can possibly be used within the scope of the disclosure.

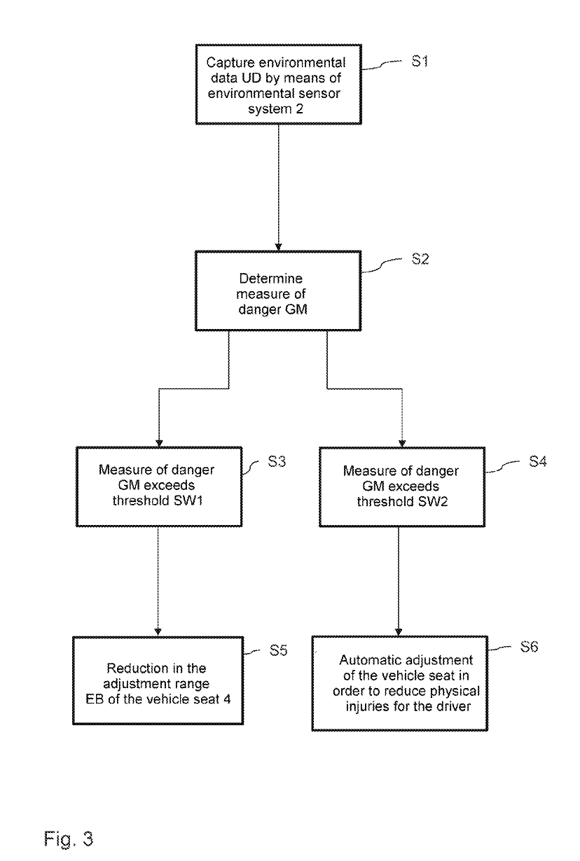

In one preferred variant of the embodiment described here, the measure of danger takes into account the detection range of the corresponding environmental sensor system 2, wherein the measure of danger represents a higher degree of danger, the shorter the detection range. The detection range may be restricted, in particular, by poor weather conditions, for example fog or rain. The measure of danger also takes into account the relative movements of road users or objects captured by the environmental sensor system with respect to the motor vehicle. The faster a road user or an object moves toward the motor vehicle 1 or the shorter the distance between the road user or object and the motor vehicle 1, the higher the degree of danger represented by the measure of danger. The adjustment range of the driver's seat 4 is changed on the basis of the measure of danger determined by the control device 3, as is explained in yet more detail further below on the basis of FIG. 3. A user interface 6 which is only schematically indicated is also provided in the motor vehicle 1. This user interface 6 comprises a display for displaying vehicle-relevant information and also makes it possible for an occupant to input instructions by means of an operating device.

FIG. 2 shows a side view of the structure of the driver's seat 4 from FIG. 1. The driver's seat comprises a backrest 401, a seating surface 402 and a headrest 403. The steering wheel 7 is situated in front of the driver's seat and the driving pedals 8 (gas pedal, brake pedal and possibly also clutch pedal) are arranged in the lower region in front of the seating surface 402, wherein only a single driving pedal 8 is indicated in FIG. 2. FIG. 2 also shows the adjustment possibilities for the driver's seat 4 by means of corresponding double-headed arrows. According to the double-headed arrow P1, the driver's seat can be pivoted about an axis A1 running in the vertical direction of the motor vehicle. In this case, it should be taken into account that the motor vehicle 1 can possibly independently move in an autonomous operating mode, with the result that in this case the driver can also pivot his driver's seat away from the position in which he can operate the steering wheel 7 and the pedals 8. In the autonomous operating mode of the motor vehicle 1, it is also possible for the steering wheel 7 and the pedals 8 to be folded away out of the vehicle interior, with the result that more space and freedom of movement are available to the driver.

As further adjustment possibilities, the driver's seat 4 as a whole can be tilted about the axis A2 running in the transverse direction of the motor vehicle 1, as indicated by the doubled-headed arrow P2. In addition, the seating surface alone (double-headed arrow P3) and the backrest alone (double-headed arrow P4) can also be moved about the axis A2. The driver's seat 4 can also be moved forward and backward in the longitudinal direction of the motor vehicle, as indicated by the double-headed arrow P5. The height position of the driver's seat can likewise be changed, as represented by the double-headed arrow P6. If necessary, yet further adjustments, for example of the headrest 403, can also be implemented. By means of the adjustment possibilities illustrated, the driver of the motor vehicle can move the driver's seat into a desired position by actuating corresponding operating elements (not shown) by controlling the actuator system 5. All of the adjustment possibilities constitute the predefined adjustment range in the sense of the patent claims.

The sequence of one embodiment of the method according to the disclosure is explained for the driver's seat 4 on the basis of FIG. 3. The steps illustrated are cyclically repeated during operation of the motor vehicle 1. As indicated in step S1 in FIG. 3, the environmental sensor system 2 captures environmental data UD. The measure of danger GM already mentioned above is determined by the control device 3 in step S2 by means of these environmental data UD. A first threshold SW1 is stored in this case in the control device. The control device also stores a second threshold SW2 which represents a measure of danger GM having a higher degree of danger than the first threshold SW1. In other words, the first threshold SW1 relates to a degree of danger which is lower than the degree of danger of the second threshold SW2.

The control device 3 determines the measure of danger GM for the occupant of the driver's seat 4 on the basis of environmental data UD relating to the motor vehicle 1. The control device 3 then determines the size of the adjustment range EB of the driver's seat 4 on the basis of the determined measure of danger GM.

If the control device 3 determines that the current measure of danger GM exceeds the first threshold SW1 (step S3), the adjustment range EB of the driver's seat 4 is suitably reduced (step S5) with the aid of the control device 3. This is effected by virtue of the control device allowing an adjustment of the seat only in a smaller range by means of the actuator system 5. All or possibly also only individual adjustment possibilities for the seat can be restricted in this case. The possibility of adjusting the vehicle seat with respect to a rotation about the axis A1 is preferably restricted, with the result that the vehicle seat can be moved away from the position shown in FIG. 2 only through a smaller angle. Reducing the adjustment range EB means that, in the event of an increased degree of danger (for example in the event of an imminent collision with an automobile), the driver's seat can no longer be moved into positions in which access to the steering wheel and the pedals takes a relatively long time. The adjustment range is preferably restricted all the more, the greater the determined measure of danger GM.

If there is an increased measure of danger GM, for example by virtue of the measure of danger exceeding the threshold SW1, the driver is made aware of this using a message. If, after reducing the adjustment range EB, the driver's seat 4 is in a position outside the reduced adjustment range, an item of information is output to the driver via the user interface 6, which information requests the driver to move the vehicle seat 4 into a position which is within the reduced adjustment range EB. If, after a corresponding reduction in the adjustment range EB, the measure of danger GM again falls below the threshold SW1 at a later time, the reduction in the adjustment range EB is cancelled again and the driver can vary the position of the driver's seat 4 again within the scope of the original adjustment possibilities.

If, despite this message, the driver does not move the driver's seat 4 into a position within the reduced adjustment range EB, the control apparatus 3 can cause the driver's seat 4 to be automatically moved into a position within the reduced adjustment range EB.

The measure of danger according to the threshold SW1 is selected in such a manner that there is not yet an acute risk of an accident for the motor vehicle with other objects in its environment.

In contrast, the second threshold SW2 represents an acute risk in the form of an imminent accident. If the determined measure of danger GM is within the first and second thresholds SW1, SW2, the adjustment range EB of the driver's seat 4 is accordingly reduced.

However, if the measure of danger GM exceeds the second threshold SW2 (step S4), automatic adjustment of the vehicle seat without intervention by the driver is initiated by means of the control device 3 (step S6). This automatic adjustment is selected in such a manner that physical injuries to the driver are kept as small as possible. Corresponding methods for such automatic adjustment are known per se. In particular, the control device 3 determines in this case the direction of the greatest application of force if the imminent accident occurs, whereupon the driver's seat 4 is moved into a position in which the seat construction optimally supports the driver sitting on it.

The above-described embodiment of the subject matter of the disclosure has numerous advantages. In particular, the degree of freedom of the adjustment of a motor vehicle seat is adaptively restricted on the basis of the measure of danger for the occupant on said seat. This ensures in a very proactive manner that the vehicle occupants and, in particular, the driver are in a position in which good perception of an imminent risk of an accident and fast access for circumventing the corresponding danger are ensured. In addition, the vehicle seat can also be automatically adjusted if necessary if there is immediate imminent danger as a result of an accident. In this case, the vehicle seat is adjusted in such a manner that harm to the vehicle occupants is minimized.

1. A method for controlling a vehicle seat of a vehicle, wherein a position of at least one of the vehicle seat and a part of the vehicle seat can be adjusted within an adjustment range, a size of which can be determined, and wherein the method comprising the steps of:
determining a measure of danger, which indicates a degree of danger for a vehicle seat occupant as a result of an accident, on a basis of environmental data relating to the vehicle; and
determining the size of the adjustment range on a basis of the determined measure of danger.

2. The method as claimed in claim 1, in which the size of the adjustment range is restricted all the more, the greater the determined measure of danger.

3. The method as claimed in claim 1, in which, if the respective position is outside the determined adjustment range, the vehicle seat or the part of it is brought into the determined adjustment range through an actuator system.

4. The method as claimed in claim 1, wherein the adjustment range comprises one or more of the following spatial ranges:
a first angular range which stipulates a permissible rotation of the vehicle seat about an axis which runs in vertical direction of the vehicle;
a second angular range which stipulates a permissible rotation of the vehicle seat about an axis which runs in transverse direction of the vehicle;
a displacement range which stipulates a permissible displacement of the vehicle seat in at least one of longitudinal and vertical direction of the vehicle; and
an inclination range which stipulates a permissible inclination of at least one of a seating surface and a backrest of the vehicle seat about an axis in the transverse direction of the vehicle.

5. The method as claimed in claim 1, in which the size of the adjustment range is not restricted as long as the determined measure of danger does not exceed a first threshold.

6. The method as claimed in claim 5, wherein the size of the adjustment range is restricted if the determined measure of danger is between the first threshold and a second threshold which represents a measure of danger having a higher degree of danger than the first threshold.

7. The method as claimed in claim 1, wherein, if the determined measure of danger exceeds a second threshold which represents a measure of danger having a higher degree of danger than a first threshold, the vehicle seat or the part of it is automatically moved into a position which constitutes little harm to the vehicle seat occupant in an event of an accident.

8. The method as claimed in claim 1, wherein a message is output to the vehicle seat occupant if there is an increased measure of danger.

9. The method as claimed in claim 1, wherein, if the vehicle seat or the part of it is in a position outside the determined adjustment range, the vehicle seat occupant is made aware of this with a message.

10. The method as claimed in claim 1, wherein the vehicle seat or a part of it is automatically adjusted into a position within the determined adjustment range if the vehicle seat or a part of it is outside the determined adjustment range.

11. The method as claimed in claim 10, wherein, if the vehicle seat or the part of it is in a position outside the determined adjustment range, the vehicle seat occupant is made aware of this with a message; and
wherein the vehicle seat or a part of it is automatically adjusted when the vehicle seat occupant does not react or does not accordingly react to the message indicating that the vehicle seat or a part of it is in a position outside the determined adjustment range.

12. The method as claimed in claim 1, wherein, if the determined measure of danger results in a reduction in the size of the adjustment range and if one or more operating elements are not in an operating position, the operating element is automatically moved into an operating position in which they can be operated by the vehicle seat occupant.

13. The method as claimed in claim 12, wherein the vehicle seat is a driver's seat and the operating element comprises at least one of a steering wheel and at least one of driving pedals.

14. The method as claimed in claim 1, wherein the environmental data contain information relating to at least one of a road user and an object in an environment of the vehicle, that is relating to at least one of relative movement of at least one of the road user and the object with respect to the vehicle, a road type currently being driven along by the vehicle, current traffic density, current weather condition and current visibility conditions.

15. The method as claimed in claim 1, wherein the environmental data comprise sensor data from an environmental sensor system installed in the vehicle, wherein the environmental sensor system preferably comprises at least one of a camera, a radar sensor, a lidar sensor, an ultrasonic sensor, and a rain sensor.

16. The method as claimed in claim 15, wherein the measure of danger increases with decreasing detection range of the environmental sensor system.

17. The method as claimed in claim 1, wherein the environmental data are at least one of at least partially received by the vehicle via at least one of vehicle-to-vehicle communication and vehicle-to-infrastructure communication and the environmental data are at least partially determined by a navigation system in the vehicle.

18. An arrangement for controlling a vehicle seat, comprising:
a seat adjustment device for adjusting a position of the vehicle seat or a part of it within an adjustment range, the size of which can be determined; and
a control device configured to:
determine a measure of danger, which indicates a degree of danger for a vehicle seat occupant as a result of an accident, on the basis of environmental data relating to the vehicle; and
determine the size of the adjustment range on the basis of the determined measure of danger.

19. The arrangement as claimed in claim 18, further comprising:
an environmental sensor system for providing the environmental data.

20. A vehicle comprising:
the arrangement as claimed in claim 18; and
a vehicle seat which can be controlled by the arrangement, wherein the vehicle seat is at least one of an adult seat, preferably a driver's seat, a passenger seat, and a child seat, wherein the child seat is preferably a child seat which is extraneous to the vehicle, is installed in the vehicle by a user and is connected to the control device via a communication interface.
